(19) United States
(12) Patent Application Publication
(10) Pub. No.: US 2012/0154617 A1
(43) Pub. Date: Jun. 21, 2012

(54) IMAGE CAPTURING DEVICE

(75) Inventor: Tsumugi MAEDA, Yokohama-shi (JP)

(73) Assignee: Samsung Electronics Co., Ltd.

(21) Appl. No.: 13/329,980

(22) Filed: Dec. 19, 2011

(30) Foreign Application Priority Data
Dec. 20, 2010 (JP) 283833/2010
Nov. 18, 2011 (KR) 10-2011-0120788

(51) Int. Cl. H04N 5/228

(52) U.S. Cl. 348/220.1; 348/222.1; 348/E05.024

(57) ABSTRACT

An image capturing device and method for improving capturing skill or knowledge by enabling a user to understand a reason for setting a proper capturing parameter. The image capturing device switches between an auto capturing mode for automatically setting capturing conditions and a manual capturing mode for manually setting capturing conditions, and includes a capturing parameter setting part that sets a capturing parameter used in the auto capturing mode, based on parameter determination information calculated from an original image, a setting reason setting part that associates and stores a setting reason for the capturing parameter value with a value of the parameter determination information corresponding to the capturing parameter, and an association processing part that determines the setting reason from the capturing parameter value in the auto capturing mode by referring to the setting reason storing part, and associating the setting reason with a captured image.

### PRIORITY

This application claims priority under 35 U.S.C. §119(a) to Japanese Patent Application Serial No. JP 283833/2010, which was filed in the Japan Patent Office on Dec. 20, 2010, and to Korean Patent Application Serial No. 10-2011-0120788, which is filed in the Korean Intellectual Property Office on Nov. 18, 2011, the entire disclosure of each of which is hereby incorporated by reference.

### BACKGROUND OF THE INVENTION

1. Field of the Invention

The present invention relates generally to an image capturing device having an auto capturing mode, such as a digital camera.

2. Description of the Related Art

Normally, a digital camera has a manual capturing mode for manually setting capturing conditions and an auto capturing mode for automatically setting the capturing conditions. In the manual capturing mode, a user sets capturing parameters, e.g., ISO speed, exposure compensation, shutter speed, white balance, red-eye correction, flash intensity, hand-shaking correction, color balance, etc.

However, it may be difficult or inconvenient for user to suitably set many capturing parameters for an object or capturing conditions.

Therefore, as described in Japanese Patent Laid-Open Publication No. 2009-200836, Japanese Patent Laid-Open Publication No. 2009-017423, and Japanese Patent Laid-Open Publication No. 2005-348298, many conventional techniques have been proposed for improving users' capturing skills.

For example, optimal capturing conditions, which have been set by a camera in a capturing operation, are recorded with a captured image, and in a subsequent capturing operation, an image corresponding to a capturing situation similar to the current capturing situation is selected to set capturing conditions of the selected image in the camera, thereby making it easier to set suitable capturing conditions.

In addition, in the recorded capturing conditions, camera functions, which are not used by the user, are detected and displayed, enabling the user to achieve suitable camera setting.

However, in these conventional techniques, a process of searching for the image corresponding to the similar capturing situation is performed during the capturing operation, resulting in a lack of the real-time feature.

Further, because a similar capturing situation is set, the set capturing conditions may not match an image the user originally desires to capture.

Furthermore, because the user is not provided with any information about which decision the capturing conditions set in the camera have been determined, the user, when desiring to manually capture an image, cannot perform a proper capturing condition setting.

### SUMMARY OF THE INVENTION

The present invention has been made to solve at least the above-described problems occurring in the prior art, and to provide at leas the advantages described below.

Accordingly, an aspect of the present invention is to enable a user to understand why proper capturing parameters are set, thereby achieving capturing skill or knowledge improvement.

In accordance with an aspect of the present invention, an image capturing device that switches between an auto capturing mode for automatically setting capturing conditions and a manual capturing mode for manually setting capturing conditions is provided. The image capturing device includes a capturing parameter setting part that sets a capturing parameter used in the auto capturing mode, based on parameter determination information calculated from an original image, a setting reason setting part that associates and stores a setting reason for the capturing parameter value with a value of the parameter determination information corresponding to the capturing parameter, and an association processing part that determines the setting reason from the capturing parameter value in the auto capturing mode by referring to the setting reason storing part, and associating the setting reason with a captured image.

In accordance with another aspect of the present invention, a method for associating a setting reason with a captured image by an image capturing device that switches between an auto capturing mode for automatically setting capturing conditions and a manual capturing mode for manually setting capturing conditions is provided. The method includes setting, by the image capturing device, a capturing parameter used in the auto capturing mode, based on parameter determination information calculated from an original image; associating a setting reason for the capturing parameter value with a value of the parameter determination information corresponding to the capturing parameter; storing the associated setting reason for the capturing parameter value with the value of the parameter determination information corresponding to the capturing parameter; determining the setting reason from the capturing parameter value in the auto capturing mode by referring to the setting reason storing part; and associating the setting reason with a captured image.

In accordance with another aspect of the present invention, a non-transitory computer readable recording medium is provided for recording a program for controlling an image capturing device, which switches between an auto capturing mode for automatically setting capturing conditions and a manual capturing mode for manually setting capturing conditions, to implement a method of associating a setting reason with a captured image. The method includes setting a capturing parameter used in the auto capturing mode, based on parameter determination information calculated from an original image; associating a setting reason for the capturing parameter value with a value of the parameter determination information corresponding to the capturing parameter; storing the associated setting reason for the capturing parameter value with the value of the parameter determination information corresponding to the capturing parameter; determining the setting reason from the capturing parameter value in the auto capturing mode by referring to the setting reason storing part; and associating the setting reason with a captured image.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates an image capturing device according to an embodiment of the present invention;

FIG. 2 is a flowchart illustrating an operation of an image capturing device according to an embodiment of the present invention;

FIG. 3 is a diagram illustrating a reason table according to an embodiment of the present invention; and

FIG. 4 is a flowchart illustrating an operation of an image capturing device according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

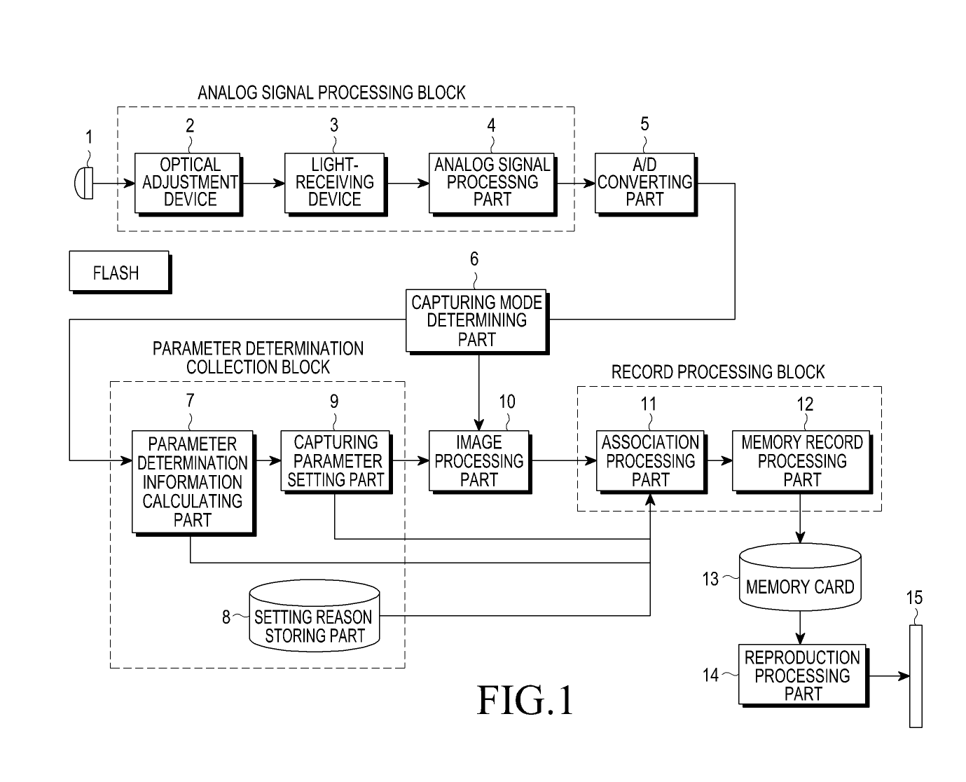

FIG. 1 illustrates an image capturing device according to an embodiment of the present invention. For example, the image capturing device in FIG. 1 may be embodied as a digital still camera.

The digital camera has an information processing device, such as a Central Processing Unit (CPU), an internal memory, etc., which is not shown, and each component illustrated in FIG. 1 includes not only a hardware device, but also a software functional unit which is achieved through the operation of the CPU or the like according to a program stored in the memory.

Referring to FIG. 1, an object is imaged through a lens 1 on an area light-receiving device 3, such as a Charge Coupled Device (CCD), a Complementary Metal-Oxide Semiconductor (CMOS), etc., and is delivered as an electric signal to an analog signal processing part 4. In the analog signal processing part 4, the signal is, for example, gain-controlled to a proper size, and the gain-controlled signal is converted into a digital signal in an Analog-to-Digital (AID) converting part 5.

Additionally, an optical adjustment device 2 adjusts, for example, aperture, shutter speed, exposure, etc., and may be a mechanical optical adjustment device, or an electric optical adjustment device working for the light-receiving device 3.

The image (Bayer-array original image) converted into the digital signal passes through a capturing mode determining part 6 and an auto parameter decision collection block, and then is delivered to an image processing part 10, in which white balance adjustment, color interpolation, YCbCr image conversion, image compression, etc., are performed, such that a resulting image (or signal) is stored in a memory card 13 through a record processing block.

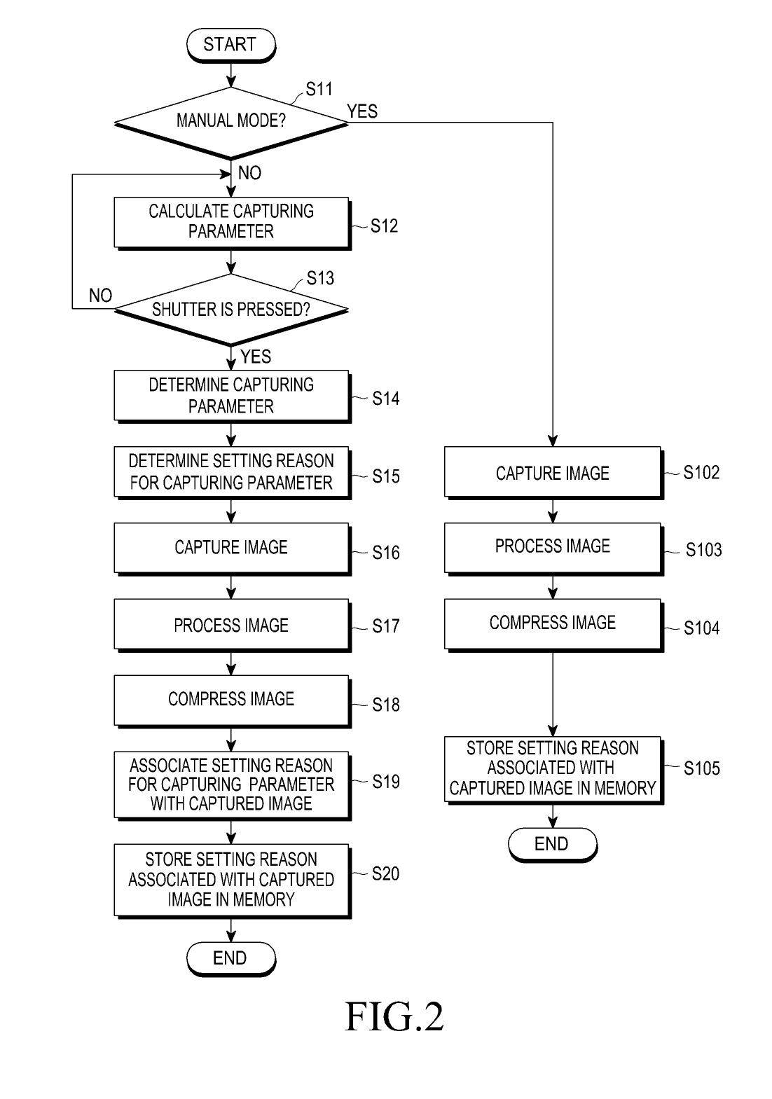

FIG. 2 is a flowchart illustrating an operation of an image capturing device according to an embodiment of the present invention.

Referring to FIG. 2, the capturing mode determining part 6 determines whether an operation mode is a manual capturing mode or an auto capturing mode, based on a user's manipulation input, in step S11.

If the operation mode is the auto photographing mode (not the manual capturing mode), before a shutter is pressed, a capturing parameter setting part 9 calculates various capturing parameter values based on parameter determination information in step S12.

For example, the capturing parameter may include ISO speed, exposure compensation, shutter speed, white balance, red-eye correction, flash intensity, hand-shaking correction, color balance, aperture, etc.

The parameter determination information is calculated by a parameter determination information calculating part 7 based on various information indicated by the original image.

For example, a value of exposure compensation, which is one of the capturing parameters, is calculated by the capturing parameter setting part 9, based on an average brightness of an original image. Herein, the brightness of the original image is the parameter determination information, and is calculated by the parameter determination information calculating part 7 from each pixel value of the original image.

For example, a value of white balance is calculated based on balance of each of R, G, and B pixel values of the original image. In addition, a value of the shutter speed may be calculated from the speed of an object's motion, which is determined from the original image, or the brightness of the original image. A value of the ISO speed may be calculated from the speed of the object's motion, which is determined from the original image, or the brightness of the original image. In addition, a value of flash intensity (e.g., ON/OFF) may be calculated from the brightness of the original image.

When the shutter is pressed in step S13, the capturing parameter is determined in step S14, and an operation in a corresponding capturing parameter is commanded to the optical adjustment device 2 or the image processing part 10, such that image capturing is performed in step S16 and image processing and/or image compression with respect to the original image is performed in step S17 and/or step S18.

A reason table including a value and a reason corresponding thereto for the parameter determination information is stored in a setting reason storing part 8 implemented in an internal memory such as a Synchronous Dynamic Random Access Memory (SDRAM) or the like.

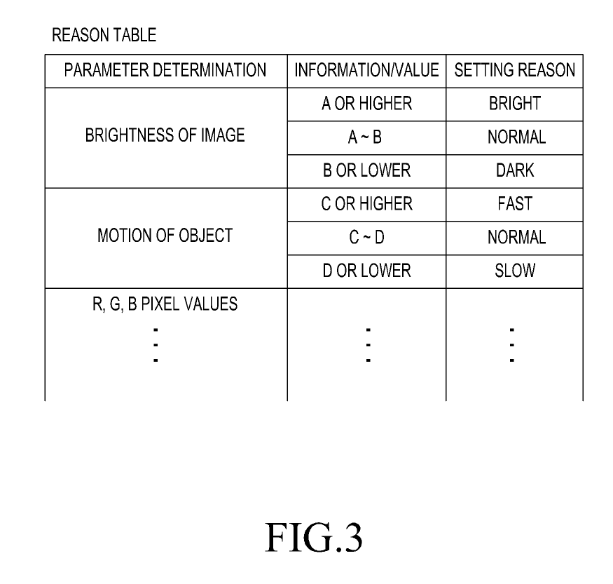

FIG. 3 is a diagram illustrating a reason table according to an embodiment of the present invention.

Referring to FIG. 3, the average brightness of the original image is divided into three areas, and “bright (image)” is added as a corresponding reason to an area corresponding to the highest brightness. “normal (image)” is added to an area corresponding to the intermediate brightness as a corresponding reason, and “dark (image)” is added to an area corresponding to the lowest brightness as a corresponding reason.

Referring again to FIG. 2, when the shutter is pressed and the capturing parameter is determined, an association processing part 11 determines a reason why each corresponding capturing parameter is set from a value of the parameter determination information used to calculate each capturing parameter value, by referring to the reason table in step S15. After image processing or image compression is performed with respect to the original image in step S16 or step S17, details of the setting reason added to each capturing parameter are associated with a compressed image in step S19.

For example, if a value of exposure correction is α, a value of the brightness of the image, which is parameter determination information used to calculate the value of exposure correction α, is β, and β is in the area corresponding to the largest brightness in the reason table, reason details such as “the reason why the value of exposure correction is α is because the image is bright” are determined. For example, a plurality of reasons may be added for a single capturing parameter.

In step S20, a memory record processing part 12 stores the setting reason associated with the compressed image in a recording medium, such as a memory card 13 or the like.

For the association with the image, the details of the setting reason may be directly inserted and recorded into an area (e.g., an App2 area), which can be embedded in maker-unique data of a Joint Photographic Experts Group (JPEG) file, may be recorded on another file as a log file to insert a file name into the App2 area, or may be recorded on another file which records association with the JPEG file and the log file.

In the manual capturing mode, according to each capturing parameter value set by the user, capturing operations as in conventional cases are performed in steps S102 through S105. Specifically, the image is captured in step S102, processing and compression are performed in steps S103 and S104, respectively, and the memory record processing part 12 stores the setting reason associated with the compressed image in a recording medium, such as a memory card 13 or the like, in step S105.

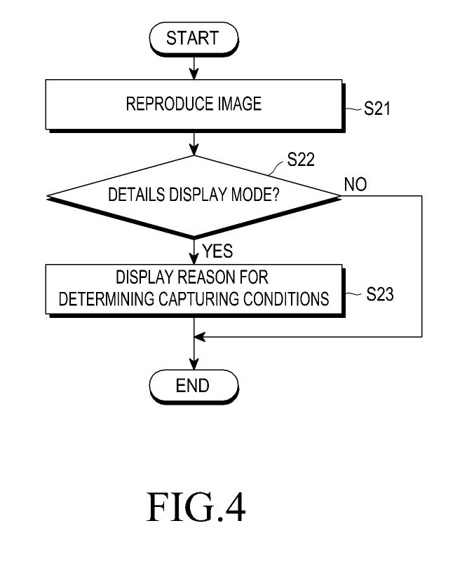

FIG. 4 is a flowchart illustrating an operation of an image capturing device according to an embodiment of the present invention.

Referring to FIG. 4, when an image is reproduced based on a user's manipulation, e.g., a reproduction processing part 14 displays the image on a display device 15, such as a Liquid Crystal Display (LCD), in step S21, and waits for a user's input regarding whether to display details of a setting reason in step S22. When the user's input commands details of the setting reason to be displayed, the reason details associated with the image are obtained from the memory, and are displayed on the display device 15 in an overlapping manner on the image or in a region separate from the image in step S23. However, when the user's input commands details of the setting reason not to be displayed or no input is received for displaying details of the setting reason, the procedure ends.

For example, the user's input regarding whether to display the details may be made by setting ON/OFF of a display in a menu, or the details may be displayed by pressing a particular button while displaying the image.

In addition, the present invention is not limited to the above-described embodiments.

For example, alternatively, a setting reason of a capturing parameter may be displayed on a live-view image prior to capturing.

Further, the same effects may be obtained even when above-described embodiments of the present invention are applied to a digital movie camera for recording a moving image or an apparatus having a complex function as well as a digital still camera.

According to the above-described embodiments of the present invention, in auto capturing, a user may be informed of a reason why a capturing parameter, which has been determined in the image capturing device, is set, such that the user can obtain knowledge about proper capturing setting. Further, because the user can understand the reasoning behind the setting of the proper capturing parameter, the user's capturing skill will be improved.

While the present invention has been shown and described with reference to certain embodiments thereof, it will be understood by those skilled in the art that various changes in form and details may be made therein without departing from the scope of the present invention as defined by the appended claims and their equivalents.

What is claimed is:

1. An image capturing device that switches between an auto capturing mode for automatically setting capturing conditions and a manual capturing mode for manually setting capturing conditions, the image capturing device comprising:
a capturing parameter setting part that sets a capturing parameter used in the auto capturing mode, based on parameter determination information calculated from an original image;
a setting reason setting part that associates and stores a setting reason for the capturing parameter value with a value of the parameter determination information corresponding to the capturing parameter; and
an association processing part that determines the setting reason from the capturing parameter value in the auto capturing mode by referring to the setting reason storing part, and associating the setting reason with a captured image.

2. The image capturing device of claim 1, further comprising a reproduction processing part for displaying the captured image with the setting reason associated with the captured image.

3. The image capturing device of claim 1, wherein the image capturing device comprises a digital still camera.

4. The image capturing device of claim 1, wherein the image capturing device comprises a digital movie camera.

5. A method for associating a setting reason with a captured image by an image capturing device that switches between an auto capturing mode for automatically setting capturing conditions and a manual capturing mode for manually setting capturing conditions, the method comprising the steps of:
setting, by the image capturing device, a capturing parameter used in the auto capturing mode, based on parameter determination information calculated from an original image;
associating a setting reason for the capturing parameter value with a value of the parameter determination information corresponding to the capturing parameter;
storing the associated setting reason for the capturing parameter value with the value of the parameter determination information corresponding to the capturing parameter;
determining the setting reason from the capturing parameter value in the auto capturing mode by referring to the setting reason storing part; and
associating the setting reason with a captured image.

6. The method of claim 5, further comprising displaying the captured image with the setting reason associated with the captured image.

7. A non-transitory computer readable recording medium for recording a program for controlling an image capturing device, which switches between an auto capturing mode for automatically setting capturing conditions and a manual capturing mode for manually setting capturing conditions, to implement a method of associating a setting reason with a captured image, the method comprising the steps of:
setting a capturing parameter used in the auto capturing mode, based on parameter determination information calculated from an original image;
associating a setting reason for the capturing parameter value with a value of the parameter determination information corresponding to the capturing parameter;
storing the associated setting reason for the capturing parameter value with the value of the parameter determination information corresponding to the capturing parameter;
determining the setting reason from the capturing parameter value in the auto capturing mode by referring to the setting reason storing part; and
associating the setting reason with a captured image.

8. The non-transitory computer readable recording medium of claim 7, wherein the method further comprises displaying the captured image with the setting reason associated with the captured image.
